(19) United States
(12) Patent Application Publication
(10) Pub. No.: US 2026/0079449 A1
(43) Pub. Date: Mar. 19, 2026

(54) WATCH COMPRISING AN ANALOGUE DISPLAY LIGHTING DEVICE

(71) Applicant: The Swatch Group Research and Development Ltd, Marin (CH)

(72) Inventor: Pierpasquale TORTORA, Neuchâtel (CH)

(73) Assignee: The Swatch Group Research and Development Ltd, Marin (CH)

(21) Appl. No.: 19/302,357

(22) Filed: Aug. 18, 2025

(30) Foreign Application Priority Data
Oct. 28, 2024 (EP) 24209295.5
Sep. 19, 2024 (EP) 24201470.2

(51) Int. Cl. G04C 17/02; G04B 19/30; G04C 10/00

(52) U.S. Cl. CPC G04C 17/02; G04B 19/30; G04C 10/00

(57) ABSTRACT

A watch (2) including a flange (14), the inner lateral surface (28) of which laterally defines a display space (70), and a lighting device (20) including a light source (10) powered by a source of electricity on the watch. The lighting device has a semi-transparent element (12) forming the flange, which is arranged above the light source and has: a lower injection surface (22) to enable injection into the semi-transparent element of a major part of the light (30) provided by said at least one light source; a lateral exit surface (26) through which a major part of the light injected into the semi-transparent element can exit; and an intermediate surface (24) to receive, with no prior reflection, a major part of the injected light, and to substantially reflect the same towards the lateral exit surface.

### CROSS REFERENCE TO RELATED APPLICATIONS

This application claims priority to European Patent Application Nos. 24201470.2, filed on September 19, 2024 and 24209295.5, filed on October 28, 2024, the entire contents of which are incorporated herein by reference.

### TECHNICAL FIELD OF THE INVENTION

The present invention relates to a watch comprising a case fitted with a glass, a movement, an analogue display device, a flange, the inner lateral surface of which defines a display space for an analogue display device, and a lighting device arranged to provide light in the display space through the inner lateral surface of the flange. The lighting device comprises at least one light source that is powered by a source of electricity on the watch.

### Technological background

Several documents from the prior art describe watches comprising a lighting device arranged so as to be able to provide light in a display space in which an analogue display, in particular hands, is at least partially located, through the inner lateral surface of a flange laterally defining the display space.

Document US 4,705,407 describes a watch flange which forms a light-diffusing bow having at least one cavity into which a light source is introduced. A similar teaching is given in document US 4,908,739 and document CH 677306. Such devices for lighting the display space do not provide an angularly homogeneous diffusion of light. In addition, the generally non-directional light sources incorporated in cavities in the flange create highly luminous zones on the inner lateral surface of the flange and also intense illumination of the respective adjacent regions in the display space and thus of the nearby dial zones, which creates a problem because the lighting of the dial is not at all uniform. This disrupts the readability of the analogue display, taking up valuable display space and creating an aesthetic problem.

Documents CH 691333 and EP 1050711 have proposed devices to resolve part of the aforementioned problems. In both of these documents, the flange consists of a light guide which is annular but not closed on itself, as at least one bed is provided along this light guide to accommodate two electroluminescent diodes (two LEDs) arranged so that their main axis of emission is tangent to a central circle of the annular light guide, so that the light from these diodes is substantially injected into the annular light guide. Then, to obtain an angularly uniform lighting of the dial, various variants are proposed to obtain an orthogonal light extraction coefficient that increases with the distance to the nearest diode, so as to obtain a substantially homogeneous light intensity for the light exiting from the flange into the display space.

These embodiments have at least two drawbacks. Firstly, the design and manufacture of light guides with an angularly variable light extraction coefficient, which must be controlled to ensure uniform lighting of the dial, are complex. Secondly, the beds provided in the flange for the diodes are unsightly and create lateral dark zones and less brightly lit adjacent zones on the dial, which runs counter to the desired objective. A particular embodiment is described with reference to FIGS. 6 and 6A in document EP 1050711, in which the problem of the unsightly, dark zone around the beds provided along the flange in the other embodiments is partially resolved. In this particular embodiment, a single shallow light source is placed under the flange forming the light guide, which then has a transverse groove with a generally triangular profile to reflect the light into the annular light guide mainly along the central geometric axis of this annular light guide, that is, tangentially to this central geometric axis and therefore perpendicular to the radius of the light guide. The groove is unsightly and also creates a darker zone along the flange. It is also understood that the amount of light that is totally injected into the display space is limited and a priori low with a single light source of the quasi-spot type.

A further lighting device for the display space, in which the hands of the analogue display device are located, is described in document EP 1094373. This lighting device makes it possible to solve the above problems to a certain extent, but the manufacture and mounting of this lighting device are relatively complex and painstaking. The intention in this case is to provide an electroluminescent strip which is vertically oriented and closed on itself to form a cylinder capable of lighting the cylindrical volume it surrounds, the cylindrical electroluminescent strip being locally extended by a connecting strip that descends vertically towards the back of the case in a lateral region of the movement. Next, a translucent plastic ring, forming a flange and intended to hold the electroluminescent strip in place in the case, is introduced inside this electroluminescent strip. According to the description, the electroluminescent strip and the connecting strip are cut from an electroluminescent sheet. It should be noted that two conductor zones/tracks separated from each other, deposited on the outer surface of the electroluminescent strip and the connecting strip, are necessary in order to be able to supply power to the electroluminescent strip. This is a complex embodiment. In addition, such an electroluminescent strip requires a power supply with a relatively high voltage and high frequency, which results in a power supply circuit that is expensive and consumes a lot of electrical energy. It should also be noted that the light produced by electroluminescent sheets of the type disclosed is blue-green, which colours the lighted surfaces with no possibility of variation (no choice of colour or white).

A dubious device for electrically connecting to a battery comprises a bent contact bracket which has to press behind the connecting strip. It will be understood that the electrical connection of the electroluminescent strip to a battery is tenuous and unsafe. Although uniform illumination of the display space is achieved, the cylindrical light-generating device, arranged behind a translucent annular flange, is relatively complex to produce, fit and electrically connect to the battery. A person skilled in the art could possibly consider replacing the disclosed cylindrical electroluminescent strip by a flexible strip such as an OLED (Organic Light Emitting Diode) which also provides a light source that is homogeneous and direct. However, flexible OLED structures are relatively difficult and costly to manufacture. Moreover, if a reliable and long-lasting OLED light source is desired, the OLEDs must be enclosed in a vacuum in a glass or crystal bed. There are flexible glass strips, but they are generally fragile. Lastly, as the OLEDs need to be hermetically sealed, sealing with a protective glass or crystal over the OLEDs requires a large substrate width relative to the width of the optically active zone. This increases the size of the lighting device, which is particularly problematic for a vertical annular structure incorporated into a watch near the analogue display.

### SUMMARY OF THE INVENTION

The invention primarily aims to solve the problems and drawbacks of the lighting devices described above. A first objective is to provide a watch fitted with a device for lighting a display space, through the inner lateral surface of a flange, that is relatively easy to manufacture and fit in the watch. Then, a second objective of the invention is to obtain a watch that is aesthetically pleasing and suitable for a high-end watch. Another objective is to provide a lighting device that produces lighting which is angularly uniform and which makes it possible in particular to light a dial homogeneously and also with a relatively high intensity.

To this end, the invention relates to a watch comprising a case fitted with a glass, a movement, an analogue display device, a flange, the inner lateral surface of which laterally defines a display space for the analogue display device, and a lighting device arranged to be able to provide light in the display space through said inner lateral surface, the lighting device comprising at least one light source powered by a source of electricity on the watch. The lighting device further comprises an at least semi-transparent element forming the flange or surrounding the flange, which in the latter case is at least semi-transparent in the direction of the display space for light provided by said at least one light source and incident on an outer lateral surface of this flange. The at least semi-transparent element is arranged above said at least one light source and has:

a lower injection surface which is configured to enable injection into the at least semi-transparent element of a major part of the light provided by said at least one light source;

a lateral exit surface through which at least a major part of the light injected into the at least semi-transparent element can exit this element to penetrate into the display space directly or respectively through the at least semi-transparent flange; and

an intermediate surface configured to receive, with no prior reflection, at least a major part of said injected light, and to substantially reflect said at least a major part of said injected light towards the lateral exit surface.

According to a preferred embodiment, the at least semi-transparent element is arranged so that the reflection of said at least a major part of said injected light is obtained by an inner reflection on its intermediate surface due to a difference in refractive indices between the at least semi-transparent element and the medium located directly behind it.

According to an advantageous variant, the at least semi-transparent element forms a bow, circular or otherwise, which is continuous and closed on itself. According to a preferred variant, the lower injection surface of this element forms a positive annular lens which is arranged so as to be able to direct, in any transverse plane perpendicular to an annular central axis of the positive annular lens, substantially all of the injected light propagating in this any transverse plane, towards the intermediate surface of the annular element.

In an advantageous embodiment, the intermediate surface of the at least semi-transparent element is configured so as to collimate, in the any aforementioned transverse plane, the light injected and directed in the direction of this intermediate surface by the positive annular lens, and so that this collimated light is substantially, preferably almost completely, incident on the lateral exit surface of the at least semi-transparent element.

In an advantageous variant, the lateral exit surface of the at least semi-transparent element is arranged to allow the collimated and incident light on this lateral exit surface to exit this element by refraction.

### BRIEF DESCRIPTION OF THE FIGURES

The invention will be described in greater detail below with reference to the appended drawings, which are given by way of non-limiting examples, in which:

FIG. 1 shows, in partial cross-section, a first embodiment of a watch according to the invention;

FIG. 2 is an enlargement of part of FIG. 1;

FIG. 3 is a perspective view of at least one semi-transparent element of the lighting device, this element forming a flange in the watch in FIG. 1;

FIG. 4 is a graph of the light intensity provided by the lighting device along a diagonal of a dial on the watch in the first embodiment;

FIG. 5 shows, in partial cross-section, a second embodiment of a watch according to the invention;

FIG. 6 shows, in horizontal cross-section, a third embodiment of a watch according to the invention;

FIGS. 7 and 8 are vertical cross-sectional views, respectively along section lines VII-VII and VIII-VIII, of the watch in FIG. 6.

### DETAILED DESCRIPTION OF THE INVENTION

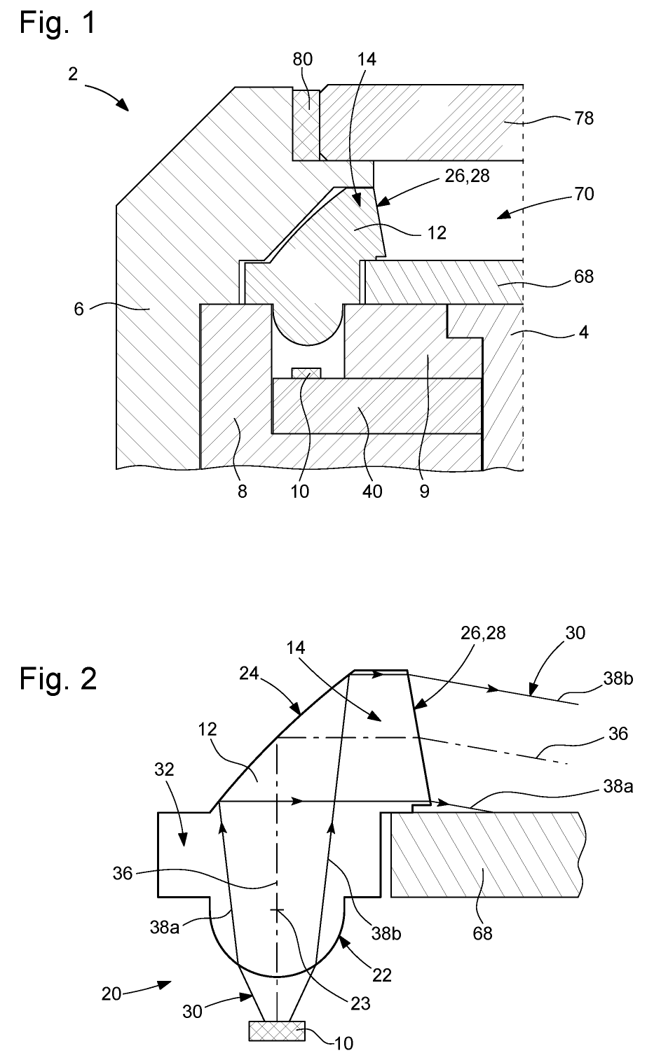

With reference to FIGS. 1 to 4, a first embodiment of a watch according to the invention will be described.

The watch 2 comprises a case 6 fitted with a glass 78, a movement 4, an analogue display device (not shown so as not to clutter the drawing), a flange 14 the inner lateral surface 28 of which laterally defines a display space 70 for the analogue display device. It should be noted that the flange does not carry the glass in the variant shown, but in another variant the flange can define an upper surface which forms a stop for the glass and with which the glass is in contact. However, in this other variant, the water-resistant seal 80 is advantageously compressed between the lateral surface of the glass and a vertical surface of the bezel of the case. In the context of the invention, the flange laterally defines, partially in the variant shown and entirely in said other variant, a display space for an analogue display.

The watch 2 further comprises a lighting device 20 arranged so as to be able to provide light 30 in the display space 70 through said inner lateral surface 28, the lighting device comprising at least one light source 10 powered by a source of electricity on the watch (not shown in this embodiment, for example an electrical energy accumulator). In a noteworthy manner, the lighting device 20 comprises an at least semi-transparent element 12, which forms the flange 14 in this first embodiment.

In general, the at least semi-transparent element 12 is arranged above said at least one light source 10 and has:

a lower injection surface 22 which is configured to enable injection into the at least semi-transparent element of a major part of the light 30 provided by said at least one light source 10,

a lateral exit surface 26 through which at least a major part of the light injected (represented by two lines 38a, 38b schematically defining an envelope for the useful light) into the at least semi-transparent element 12 can exit from this at least semi-transparent element to penetrate into the display space 70, and

an intermediate surface 24 that is configured to receive, with no prior reflection, at least a major part of said injected light 38a, 38b, and to substantially reflect said at least a major part of said injected light towards the lateral exit surface 26.

In the first embodiment, the lateral exit surface 26 of the at least semi-transparent element 12 is coincident with the inner lateral surface 28 of the flange 14, the latter being formed by the element 12 which thus defines the inner lateral surface 28.

According to an advantageous variant, the at least semi-transparent element 12 is arranged so that the reflection of said at least a major part of said injected light is an inner reflection on the intermediate surface due to a difference in refractive indices between the at least semi-transparent element and the medium located directly behind it. namely the refractive index of the air in the variant shown. By way of example, the at least semi-transparent element is made of plastic, more specifically polycarbonate with a refractive index n = 1.65.

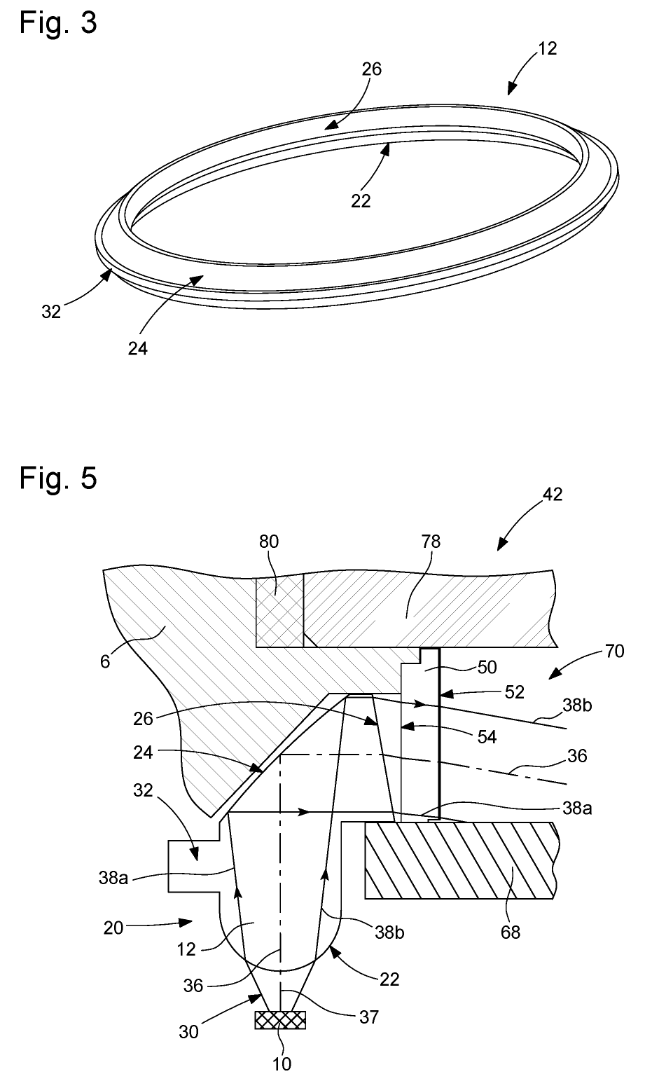

According to a preferred variant, as shown in FIG. 3, the at least semi-transparent element 12 forms a bow, circular in the variant shown or otherwise in other variants, which is continuous and closed on itself. This is very useful so as to avoid at least one darker or luminous zone along the flange. As said at least one light source is located below the annular element 12, it is easily possible to arrange this at least one light source so that it is uniform along the annular element 12 or optionally periodic, with several electroluminescent diodes (acronym: LED, for “Light Emitting Diode”) spaced with an angular step, in particular of 30°, to light the zones with the hour marks/indices more brightly.

According to an advantageous characteristic of the invention, the lower injection surface 22 of this at least semi-transparent element 12 forms a positive annular lens which is arranged so as to be able to direct, in any transverse plane perpendicular to an annular central axis 23 of the positive annular lens, substantially all of the injected light propagating in this any transverse plane, towards the intermediate surface 24. By way of example, the positive annular lens has a substantially semi-circular cross-section with a radius of curvature r = 0.6 mm. For an annular element 12 made of polycarbonate, a focal distance f = 0.4 mm is obtained, To obtain a non-negligible light intensity over substantially the entire lateral exit surface 26, the light source must be located relatively close to the entry surface, preferably substantially at the focal distance. In the latter case, given the extent of the light source, the light beam 30 has a certain opening when it is incident on the intermediate surface 24. A person skilled in the art will be able, using appropriate calculation tools, to define the optimum position for each light source in particular according to the dimensions and to the configuration of the annular element 12, of the extent of the source and optionally of its emission lobe.

According to another advantageous characteristic, said at least one light source 10 is arranged so that a main emission axis 37 of each light source or a main emission surface of the light source, when the latter is extended, is substantially vertical and coincident, at all times, with an annular optical surface of the positive annular lens 22, this annular optical surface being defined by the vertical optical axis 36 that the positive annular lens has in said any transverse plane (plane in FIGS. 1 and 2).

In a first variant, said at least one light source is formed by a virtually direct or direct annular source, in particular of the OLED (Organic Light Emitting Diode) type. The fact that the light source 10 is located under the at least semi-transparent annular element 12, which directs the light towards the display space 70, is advantageous in particular for a virtually direct or direct annular OLED source, because the annular rest can be flat, which makes it possible to obtain such a light source without having to bend the rest to give it an annular curvature as in the case of a light source that is arranged laterally on the outside of an annular element for transmitting the light towards the display space. In a second variant, said at least one light source is formed by a plurality of relatively small light sources, in particular LEDs, that are spaced uniformly along the at least semi-transparent annular element 12, for example twelve or twenty-four in number. With micro-LEDs, a large number of these can be provided on a flat annular rest.

In an advantageous variant, the intermediate surface 24 is configured to collimate, in said any transverse plane, said light injected and directed in the direction of this intermediate surface by the positive annular lens 22, and so that this collimated light is, at least for the most part and preferably substantially in its entirety, incident on the lateral exit surface 26. To this end, the transverse profile of the intermediate surface 24 is a Bezier curve that can be defined by specific computer software. It should be noted that the transverse profile of the intermediate surface 24 can be optimised using computer software, based on said at least one light source, in particular its arrangement, and on the dimensions of the annular element 12.

According to a particular characteristic, the intermediate surface 24 is configured so that said collimated light has an optical axis of propagation 36 that is horizontal between the intermediate surface and the lateral exit surface 26 through which the light beam 30 exits the at least semi-transparent annular element 12.

According to one advantageous characteristic, the lateral exit surface 26 is arranged to allow the collimated light beam 30, incident on this lateral exit surface, to exit the at least semi-transparent element 12 by refraction. It should be noted that the lateral exit surface 26, which defines the inner lateral surface 28 of the flange 14, can undergo various treatments, particularly for aesthetic purposes. For example, PVD deposition of a very thin layer of metal can be foreseen so as to give a metallic appearance for a user of the watch, while guaranteeing sufficient and even almost complete transparency for the light 30 propagating along the axis of propagation 36 and incident on this lateral exit surface. In particular, the lateral exit surface 26 defines, in said any transverse plane, a straight segment which is oriented so that an axis of propagation 36 of said collimated light 30 incident on the lateral exit surface 26 is inclined in the direction of movement 4 at the exit of the at least semi-transparent element 12. In the variant shown in which the propagation axis 36 is horizontal between the surfaces 24 and 26, said straight segment is oblique and the lateral exit surface 26 is frustoconical. It should be noted that for certain watches, it can be advantageous, particularly for aesthetic reasons, to provide a flange with a vertical lateral surface, that is, cylindrical and in particular circular. In this case, the lighting device, in particular the intermediate surface 24, is arranged so that the axis of propagation of the light beam between surfaces 24 and 26 is inclined downwards towards the display space 70, which can be further advantageous to have a greater inclination of the optical axis after the lateral exit surface 26.

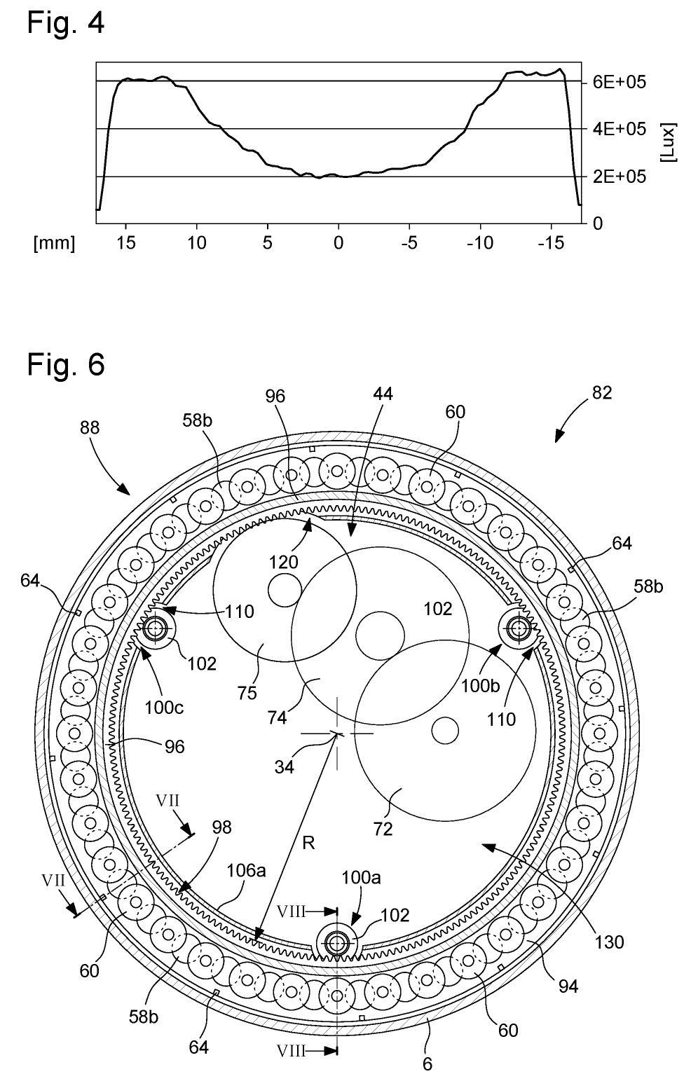

In a general variant, the watch comprises a dial 68 arranged on movement 4. The direction of the axis of propagation 36 of the collimated light 30 exiting the at least semi-transparent element 12 is chosen so that this collimated light is substantially incident directly on the dial. In an advantageous variant, the lighting device is arranged so that the dial can be reached at least almost at every point which can be observed orthogonally to the dial by the user of the watch, directly by the collimated light exiting from the at least semi-transparent element 12. In a preferred variant, in which the at least semi-transparent element 12 is circular, the lighting device is arranged so that the collimated light exiting from this semi-transparent element is, in said any transverse plane, incident on the dial between the inner lateral surface of the flange and a central axis of said display space. FIG. 4 shows, for a specific version of the watch according to the invention, a graph of the light flux, according to one diameter of the dial, incident on the latter.

In the variant shown, the watch 2 comprises a fitting circle 8 for the movement 4. The fitting circle 8 has an extra outer annular thickness against which an outer shoulder/protruding part 32 of the annular element 12 presses. An annular rest 40 (a PCB) is arranged inside the extra annular thickness and at the periphery of the movement 4, on which rest said at least one light source 10 is arranged, along with conductor tracks for its electrical connection to an electrical energy source. An annular spacer 9 is located on the rest 40 inside said at least one light source 10 and the positive annular lens 22. This annular spacer has, on the outside, an annular surface on which a lower shouldering of the annular element 12 can rest and, on the inside, a step defining a shouldering for an upper and outer protruding part of the movement 4. The dimensions and tolerances will be determined by the person skilled in the art, in particular so that the part of the annular element forming the flange 14 is kept in a fixed position between the inner part of the case 6 carrying the glass 78 and the dial 68 with no undesirable slots. Other arrangements and attachment means for the annular element 12, for said at least one light source 10 and for the movement can of course be provided.

FIG. 5 shows a second embodiment of a watch 42 according to the invention. This second embodiment differs from the first embodiment essentially in that the at least semi-transparent element 12 does not form the flange, but externally surrounds a flange 50, which in this case is at least semi-transparent in the direction of the display space 70 for light provided by said at least one light source 10 and incident on an external lateral surface 54 of this flange. “Outside” is to be understood as a lateral surface opposite an inner lateral surface 52 of the flange 50, which defines the display space 70. The inner lateral surface 52 can be treated to mask the transparency of the flange from a user of the watch, in particular by a metallic PVD deposition. In one variant, the flange 50 is arranged so as to be substantially transparent to light from said at least one light source in the direction running through the flange towards the display space and substantially opaque in the other direction to light propagating in that display space.

The other elements or parts already referred to and described in connection with the first embodiment will not be described again here. It should be noted that the at least semi-transparent annular element 12 is optically similar to the one already described in the first embodiment, with only part of its outer outline being different but the surfaces 22, 24 and 26 are essentially identical. It should be noted that other flange arrangements are also possible. In an advantageous variant, the at least semi-transparent element 12 has a height, between the dial 68 and the glass 78, that is substantially equal to the height of the flange 50, which has an upper surface defining a support for the glass 78. In this case, the outer lateral surface 54 of the flange, provided with a substantially rectangular cross-section (that is, without the upper offset shown in FIG. 5), is preferably located vertically in the thickness of the water-resistant seal 80. In this variant, attaching the flange to the dial or to the annular element can be advantageous.

With reference to FIGS. 6 to 8, a third embodiment of a watch according to the invention will now be described. The watch comprises a device for lighting a display space, this lighting device being powered by a mechano-electric generator. Various previously described characteristics of the invention will not be described again. In particular, the at least semi-transparent annular element 12a is optically similar to the annular element 12 already described in the first embodiment, the only difference being the absence of an external shoulder. The optically active surfaces, namely 22, 24 and 26, are essentially identical.

The watch 82 comprises a case 6 incorporating a movement 44 (partially shown in FIG. 6; it is located between the dial 68 and the back of the case) and a mechano-electric generator 88 located in a region peripheral to the movement. The generator comprises a stator 90 and a rotor 92, which has an annular structure and is rotationally guided by at least two ball bearings, preferably three ball bearings 100a, 100b, 100c. Generally speaking, the watch 82 comprises a plurality of ball bearings with a diameter less than the inner radius R of the rotor, preferably less than half this inner radius. Each ball bearing in said plurality comprises a fixed part 101 and a mobile part 102 running between the fixed part and the rotor 92, each mobile part and the rotor being configured so that the rotor is supported only by the plurality of mobile parts in the plurality of ball bearings and is capable of rotating around the central geometrical axis 34 of the rotor, which is its axis of rotation. Each bearing conventionally comprises balls 103 between its fixed part and its mobile part. The particular aspect of this embodiment is that the mobile part of the ball bearings is not attached to the peripheral annular rotor 92 and is therefore not part of this rotor. The mobile parts roll along a track 97 machined laterally in an inner part 96 of the rotor.

The track 97, for example, has a cross-sectional profile defining three straight segments, the dimensions of which are designed so that each mobile part 102 has a small clearance in the groove forming said track and is in contact along the said profile, according to the spatial direction of the watch, at one point or two points. Preferably, in this advantageous embodiment, each ball bearing is located on the inner side of the rotor and each fixed part is mounted in the movement 44. In one variant, the fixed parts 101 are mounted on a fitting circle of the movement. The rotor 92 has internal toothing 98 that meshes with a wheel 75 of a drive train (wheels 74 and 75) arranged between a barrel 72 and the rotor. The drive mechanism on the generator is designed so that it can drive the generator on command in a controlled manner, in particular with a rotational speed higher than a minimum speed required for the lighting device to function correctly, depending on the generator arrangement 88, as long as the barrel is wound above a lower threshold.

Over its entire height, the rotor 92 has a free interior space 130, through which the rotor's geometric axis of rotation 34 runs and in which the movement 44 is partially located. Next, the rotor 92 is located substantially entirely in a space peripheral to the movement. In fact, in the variant shown, only the three ball bearings associated with the rotor and supporting the latter, leaving it free to rotate, and the drive wheel 75, which meshes with the internal toothing 98 of the rotor, are in contact with the rotor 92 and located inside the latter. It can therefore be said that, in the variant shown, the rotor is located entirely in a space peripheral to movement 44. Moreover, the stator 90 on the generator is also located substantially entirely in a space peripheral to the movement. In fact, while the recesses 110 and 120 in the stator are not considered to be part of the volume of the stator itself, it can be said that the stator is also located entirely in a space peripheral to the movement. Hence, the mechano-electric generator 88 is arranged substantially entirely, preferably entirely, in a space peripheral to the movement of the watch.

The rotor 92 advantageously carries the coils 60, which are connected, directly or via an electric circuit with no accumulator and, as the case may be, an electronic circuit, to the lighting device, formed by a plurality of electroluminescent diodes 64 (LEDs 64) fixedly arranged on the rotor. More specifically, the rotor comprises an annular rest 94, forming a rigid PCB (“Printed Circuit Board”), that has circular openings in which the coils 60 are located, which are firmly attached to the annular rest 94 which is itself carried by the inner part 96 of the rotor. The LEDs, the various electrical connections forming an electrical circuit and, as the case may be, any electronic circuits other than the LEDs, are arranged on and carried by the PCB. The rotor thus carries all of the electrical and electronic equipment of the lighting device, formed by the plurality of LEDs, the coils of the generator 88, the electric interconnection circuit and, where appropriate, any other electrical or electronic component relating to the lighting device and to the mechano-electric generator that powers it.

The stator 90 comprises a first series of permanent bipolar magnets 58a, with axial magnetisation, which are carried at the bottom by a first part 106a of an annular ferromagnetic structure forming a magnetic circuit for closing the magnetic fields of the first series of magnets 58a and also of the second series of permanent magnets 58b carried at the top by the second part 106b of the annular structure, which is fixed. The annular structure includes recesses 110, for the ball bearings 100a, 110b and 110c, and a recess 120 for the drive wheel 75. These recesses are machined in the lateral wall (axial/vertical wall) and optionally, as shown, also in the second part 106b (lower part on the back side of the case) to make it easier to fit the ball bearings and the drive wheel 75.

In a first variant shown in FIG. 6, the number of magnets in each series of magnets is equal to the number of coils foreseen, this number being thirty-six in the variant shown. In an advantageous and non-limiting manner, said number is foreseen to be between twenty and forty. In a second variant, the mechano-electric generator comprises twice as many magnets per series as there are coils, the magnets in each series having alternating polarities.

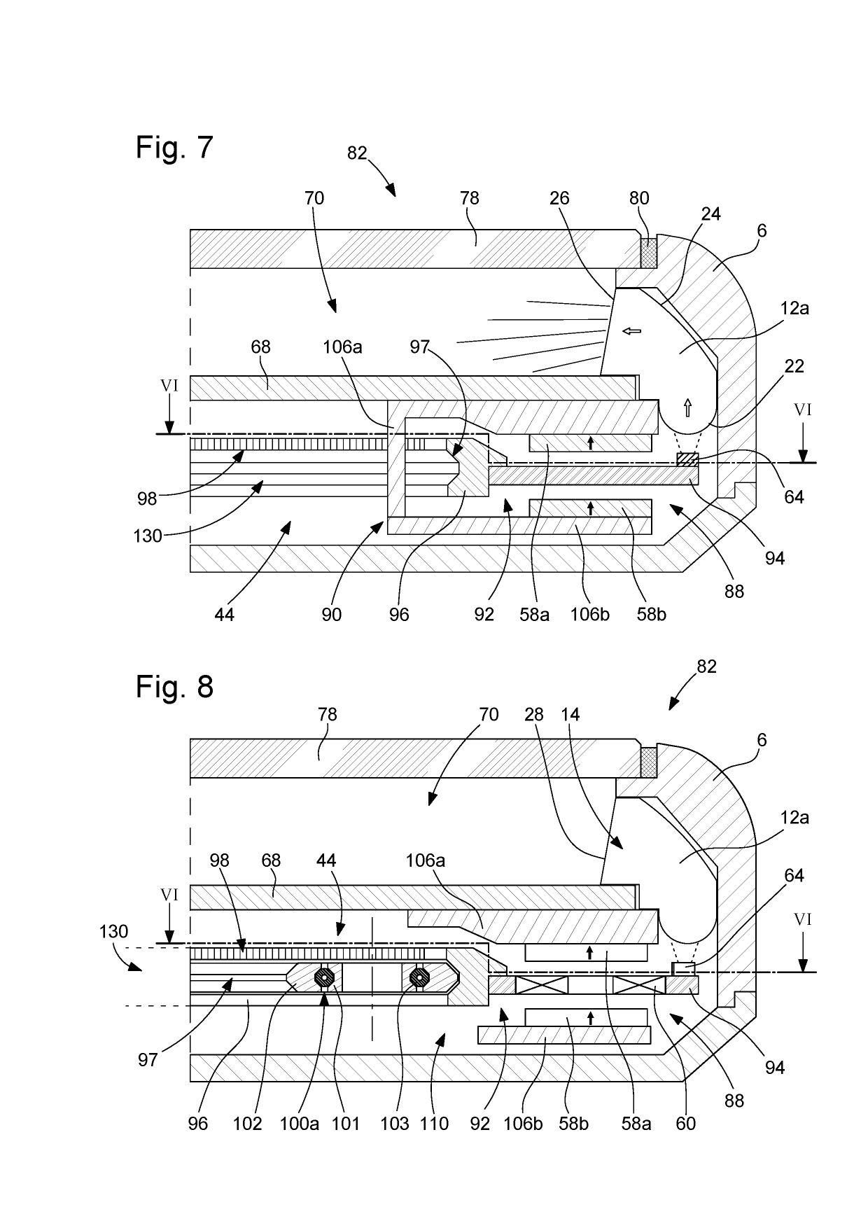

The lighting device comprises an at least semi-transparent annular element 12a, similar to that described in the first embodiment. This annular element is arranged to guide the light produced by the lighting device, namely the LEDs 64, towards a display space 70, in which an analogue display device (not shown) on the watch is located, the display space being located between the dial 68 and the upper glass 78. According to a variant shown in FIGS. 7 and 8, the annular element 12a forms a flange on the watch surrounding the display space 70. In the variant embodiment described in this case, it is advantageous for the LEDs 64 to be located on the outer side of the coils 60, given that the annular element 12a forms a flange and is therefore a part located on the periphery of the dial 68.

The third embodiment offers a major advantage in terms of lighting the display space 70. This major advantage arises from the fact that the LEDs are arranged on the rotor and therefore rotate along with it. In this way, the frustoconical surface 26 of the annular element 12a, defining the flange, is scanned by the light produced by each of the LEDs in a tangential direction perpendicular to the rotational axis 34, or in other words in an angular direction. With a relatively small number of LEDs, for example twelve as shown in FIG. 3, and a sufficiently high rotational speed of the rotor, for example two to four rotations / second, the user's eye perceives quasi-homogeneous and quasi-stationary lighting of the display space because the lighting only takes place when the generator is activated and the rotor is rotated, with the electrical energy generated being provided instantaneously to the LEDs 64.

1. A watch (2, 42, 82) comprising a case (6) fitted with a glass (78), a movement, an analogue display device, a flange (14, 50), the inner lateral surface (28, 52) of which laterally defines a display space (70) for the analogue display device, and a lighting device (20) arranged to be able to provide light in the display space through said inner lateral surface, the lighting device comprising at least one light source (10, 64) powered by a source of electricity on the watch;
wherein the lighting device comprises an at least semi-transparent element (12, 12a) forming the flange or surrounding the flange, which in the latter case is at least semi-transparent in the direction of the display space for light supplied by the at least one light source and incident on an outer lateral surface of this flange; and
wherein the at least semi-transparent element is arranged above said at least one light source and has:
a lower injection surface (22) which is configured to enable injection into the at least semi-transparent element of a major part of the light (30) provided by said at least one light source,
a lateral exit surface (26) through which at least a major part of the light injected into the at least semi-transparent element can exit this element to penetrate into the display space directly or respectively through the at least semi-transparent flange, and
an intermediate surface (24) configured to receive, with no prior reflection, at least a major part of said injected light, and to substantially reflect said at least a major part of said injected light towards the lateral exit surface.

2. The watch according to claim 1, wherein the at least semi-transparent element (12, 12a) is arranged so that the reflection of said at least a major part of said injected light is an inner reflection on the intermediate surface (24) due to a difference in refractive indices between the at least semi-transparent element and the medium located directly behind it.

3. The watch according to claim 1, wherein the at least semi-transparent element (12, 12a) forms a bow, circular or otherwise, which is continuous and closed on itself.

4. The watch according to claim 3, wherein said lower injection surface (22) of the at least semi-transparent element forms a positive annular lens which is arranged so as to direct, in any transverse plane perpendicular to an annular central axis (23) of the positive annular lens, substantially all of the injected light propagating in this any transverse plane, towards said intermediate surface (24).

5. The watch according to claim 4, wherein said at least one light source (10, 64) is arranged so that a main emission axis or, as the case may be, a main emission surface of this light source is vertical and substantially coincident, at all times, with an optical surface of the positive annular lens, this optical surface being formed by a vertical optical axis which the positive annular lens has in said any transverse plane.

6. The watch according to claim 4, wherein said at least one light source is formed by a virtually direct or direct annular source (10), in particular of the OLED type, or by a plurality of light sources (64), in particular LEDs, distributed uniformly along the at least semi-transparent element (12, 12a).

7. The watch according to claim 4, wherein said intermediate surface (24) is configured to collimate, in said any transverse plane, said light injected and directed in the direction of this intermediate surface by the positive annular lens, and so that this collimated light is, preferably substantially in its entirety, incident on the lateral exit surface (26).

8. The watch according to claim 7, wherein said intermediate surface (24) is configured so that said collimated light has an optical axis of propagation (36) which is horizontal subsequent to reflection on said intermediate surface.

9. The watch according to claim 7, wherein said lateral exit surface (26) is arranged to allow the collimated light incident on this lateral exit surface to exit the at least semi-transparent element by refraction.

10. The watch according to claim 9, wherein the lateral exit surface (26) defines, in said any transverse plane, a straight segment which is oriented so that an axis of propagation (36) of said collimated light incident on the lateral exit surface is inclined in the direction of movement at the exit of the at least semi-transparent element.

11. The watch according to claim 10 and comprising a dial (68) arranged on the movement (4, 44), wherein the direction of the axis (36) of propagation of the collimated light exiting the at least semi-transparent element (12, 12a) is chosen so that this collimated light exiting this at least semi-transparent element is substantially incident directly on the dial.

12. The watch according to claim 11, wherein the lighting device (20) is arranged so that the dial can be reached at least almost at every point which can be observed orthogonally to the dial by a user of the watch, directly by the collimated light exiting from the at least semi-transparent element.

13. The watch according to claim 11, in which the at least semi-transparent element (12, 12a) is circular, wherein the collimated light exiting from this at least semi-transparent element is, in any transverse plane, incident on the dial between the inner lateral surface (26, 52) of the flange (14, 50) and a central axis (34) of said display space (70).

14. The watch according to claim 1, wherein the at least semi-transparent element (12, 12a) forms said flange (14), the inner lateral surface (28) of the flange being coincident with said lateral exit surface (26).

15. The watch according to claim 1, wherein the at least semi-transparent element (12) surrounds the flange (50), which is at least semi-transparent in the direction of the display space (70) for light supplied by said at least one light source (10) and incident on an outer lateral surface (54) of said flange.

16. The watch according to claim 1, wherein the source of electricity is a mechano-electric generator (88) incorporated into the watch (82) and comprising a rotor (92).

17. The watch according to claim 16, wherein the mechano-electric generator (88) comprises coils (60), said rotor (92) carrying the coils and said at least one light source (64).
